(19) United States
(12) Patent Application Publication
(10) Pub. No.: US 2020/0248046 A1
(43) Pub. Date: Aug. 6, 2020

(54) Hot Melt Adhesive Compositions

(71) Applicant: ExxonMobil Chemical Patents Inc., Baytown, TX (US)

(72) Inventors: Ling Ge, Shanghai (CN); Jean-Roch H. Schauder, Wavre (BE); Jerome Sarrazin, Sint-Stevens Woluwe (BE); Bastien Filliol, Guidel Bretagne (FR); Jennifer J. Austin, The Woodlands, TX (US); Angela V. Carey, Summit, NJ (US); Ye Chun Zhou, Shanghai (CN)

(21) Appl. No.: 16/738,694

(22) Filed: Jan. 9, 2020

Related U.S. Application Data
(60) Provisional application No. 62/800,752, filed on Feb. 4, 2019.

(51) Int. Cl. C09J 123/14

(52) U.S. Cl. CPC C09J 123/14; C08L 91/06

(57) ABSTRACT

In an embodiment, an adhesive composition includes (a) a propylene-based elastomer comprising at least 60 wt % of propylene-derived units and from 2-40 wt % of a C₂ and/or a C₄-C₂₀ α-olefin-derived units based on a total weight of the propylene-based elastomer, and having a melting temperature of less than 110° C., a heat of fusion of less than 75 J/g, and a weight average molecular weight (Mw) of less than 100,000 g/mol; (b) a polyethylene wax having a density of greater than 0.940 g/cm³, a Mw of from 3,000 g/mol to 30,000 g/mol, and a crystallization temperature of greater than 100° C.; (c) a tackifier; and (d) optionally a polypropylene wax. In another embodiment, an adhesive composition includes 70-80 wt % of a propylene-based elastomer; 10 wt % of a polyethylene wax; 0-10 wt % of a polypropylene wax; and 10 wt % of a tackifier based on a total weight of the adhesive composition.

### CROSS-REFERENCE TO RELATED APPLICATIONS

This application claims priority to U.S. Ser. No. 62/800,752, filed Feb. 4, 2019, herein incorporated by reference.

### FIELD

Embodiments of the present disclosure generally relate to polyolefin adhesive compositions, and more particularly, to the use of polyolefin adhesive compositions for hot melt adhesive applications.

### BACKGROUND

A hot melt adhesive (HMA) is a thermoplastic polymer system that can be applied to a substrate in a molten state and then placed in contact with one or more other substrates. The adhesive cools and solidifies to form a bond between the substrates. Hot melt adhesives are used extensively in the packaging industry, e.g., to seal and close cartons or to laminate multilayer papers, and accordingly, the industry continues to search for adhesive compositions having a balance of, e.g., the following properties—set time, bonding strength, cohesive strength, fiber tear value, and low viscosity.

The hot melt adhesive should have good adhesion over a wide temperature range, e.g., at low temperatures for packaging applications in the frozen-goods sector, and a low viscosity melt to facilitate application to the substrate, especially for automatic processing. The hot melt adhesive should have, on the one hand, a moderate to long open time, defined as the time span between adhesive application to a first substrate and assembly of the parts to be joined. On the other hand, a fast set time is required to quickly build up bond strength on fast-running packaging machines. The characteristic set time is defined as the time needed for the hot melt adhesive to solidify to the point where it possesses enough bond strength to form bonds to give substrate fiber tear when pulled apart, e.g., the bond is sufficiently strong such that sealed substrates will not pop open upon exit from the compression section on a packaging line. The bond may continue to build additional strength upon further cooling; however, compression is no longer required to maintain adhesion between the substrate surfaces.

Thermoplastic polymers, particularly ethylene-based polymers such as ethylene-vinyl acetate copolymers (EVA) have traditionally been used in hot melt adhesive formulations, but often the adhesive formulation requires substantial use of low molecular weight ingredients such as wax and tackifier to adjust the viscosity and glass transition temperature to useful ranges. Thus, EVA formulations are typically exemplified by a wax with either a low molecular weight or a low crystallization temperature.

Generally selecting optimum performance is a matter of trading off one property against another, for example, reducing set time decreases adhesion at low temperature. It is challenging to obtain the desired balance among set time, bonding strength and low viscosity. Conventional hot melt adhesives are optimized either for good adhesion, while sacrificing set time, or for a fast set time, while sacrificing adhesion at low temperatures.

There is a need for adhesive compositions having advantageous processing properties such as an improved (reduced) set time, improved bonding strength, improved cohesive strength, and low viscosity.

### SUMMARY

In an embodiment, an adhesive composition is provided. The adhesive composition includes (a) a propylene-based elastomer comprising at least 60 wt % of propylene-derived units and from 2 wt % to 40 wt % of a C₂ and/or a C₄-C₂₀ α-olefin-derived units based on a total weight of the propylene-based elastomer, and having a melting temperature of less than 110° C., a heat of fusion of less than 75 J/g, and a weight average molecular weight (Mw) of less than 100,000 g/mol; (b) a polyethylene wax having a density of greater than 0.940 g/cm³, a weight average molecular weight (Mw) of from 3,000 g/mol to 30,000 g/mol, and a crystallization temperature of greater than 100° C.; (c) a tackifier; and (d) optionally a polypropylene wax.

In another embodiment, an adhesive composition is provided. The adhesive composition includes 70 wt % to 80 wt % of a propylene-based elastomer based on a total weight of the adhesive composition; 10 wt % of a polyethylene wax based on the total weight of the adhesive composition; 0 wt % to 10 wt % of a polypropylene wax based on the total weight of the adhesive composition; and 10 wt % of a tackifier based on the total weight of the adhesive composition.

Other and further embodiments are described below.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrate only exemplary embodiments and are therefore not to be considered limiting of its scope, for the disclosure may admit to other equally effective embodiments.

FIG. 1 shows Differential Scanning calorimetry (“DSC”) of example adhesive compositions according to some embodiments.

FIG. 2 shows the correlation of ΔT_{c} and set time of example adhesive compositions according to some embodiments.

FIG. 3 shows kinetic characteristics of example adhesive compositions according to some embodiments.

FIGS. 4 shows DSC curves of example and comparative adhesive compositions according to some embodiments.

FIGS. 5A and 5B show rheological characteristics of example adhesive compositions according to some embodiments.

### DETAILED DESCRIPTION

Embodiments of the present disclosure relate to polyolefin adhesive compositions for hot melt adhesive applications. As noted above, conventional hot melt adhesives are optimized for certain properties (e.g., adhesion) while sacrificing other properties (e.g., set time). However, the adhesive industry needs adhesive compositions having advantageous processing properties such as a shorter set time, improved bonding strength, improved cohesive strength, and low viscosity. The inventors have discovered that an adhesive composition that includes: (a) a propylene-based elastomer blend comprising at least about 60 wt % of propylene and from about 2 wt % to about 40 wt % of a C₂ and/or a C₄-C₂₀ α-olefin based on a total weight of the propylene-based polymer, and having a melting temperature of less than about 110° C., a heat of fusion of less than about 75 J/g, and a weight average molecular weight of less than about 100,000 g/mol; (b) a polyethylene wax having a density of greater than about 0.940 g/cm³, a weight average molecular weight of from about 3,000 g/mol to about 30,000 g/mol, and a crystallization temperature of greater than about 100° C.; (c) a tackifier; and (d) optionally a polypropylene wax exhibits both improved adhesion performance with improved (reduced) set times.

In some embodiments, said adhesive is a hot melt adhesive. Hot melt adhesives are adhesives that are typically solid (or exhibit glass like cold flow) at use temperature (such as room temperature, e.g., 23° C.) and molten at application temperatures such as about 120° C. or more (such as about 130° C. or more, such as about 140° C. or more, such as about 160° C. or more).

For purposes of this disclosure, when a polymer or oligomer is referred to as comprising an olefin, the olefin present in the polymer or oligomer is the polymerized or oligomerized form of the olefin, respectively.

For purposes of this disclosure, the use of the term “polymer” is meant to encompass homopolymers and copolymers.

For purposes of this disclosure, the term “copolymer” is used herein to include any polymer having two or more monomers. That is, in the case of a propylene copolymer, at least one other comonomer is polymerized with the propylene to make the copolymer.

### Propylene-Based Elastomer

In any embodiment, the propylene-based elastomer includes one or more propylene based elastomers. In some embodiments, the propylene-based elastomer is a random copolymer having crystalline regions interrupted by non-crystalline regions and within the range from about 5 wt % to about 25 wt %, by weight of the propylene-based elastomer, of ethylene or C₄ to C₁₀ α-olefin derived units, and optionally diene-derived units, the remainder of the polymer being propylene-derived units. Not intended to be limited by any theory, it is believed that the non-crystalline regions may result from regions of non-crystallizable polypropylene segments and/or the inclusion of comonomer units. The crystallinity and the melting point of the propylene-based elastomer are reduced compared to highly isotactic polypropylene by the introduction of errors (stereo and region defects) in the insertion of propylene and/or by the presence of comonomer. The propylene-based elastomer contains at least about 60 wt % propylene-derived units by weight of the propylene-based elastomer. In any embodiment, the propylene-based elastomer is a propylene-based elastomer having limited crystallinity due to adjacent isotactic propylene units and a melting point as described herein. In other embodiments, the propylene-based elastomer is generally devoid of any substantial intermolecular heterogeneity in tacticity and comonomer composition, and also generally devoid of any substantial heterogeneity in intramolecular composition distribution. In some embodiments, the propylene-based elastomer contains greater than about 50 wt %, such as greater than about 60 wt %, such as greater than about 65 wt %, such as greater than about 75 wt % and up to about 99 wt % propylene-derived units, based on the total weight of the propylene-based elastomer. In some embodiments, the propylene-based elastomer includes propylene-derived units in an amount based on the weight of propylene-based elastomer of from about 75 wt % to about 95 wt %, such as from about 75 wt % to about 92.5 wt %, such as from about 82.5 wt % to about 92.5 wt %, such as from about 82.5 wt % to about 90 wt %. Correspondingly, the units, or comonomers, derived from at least one of ethylene or a C₄ to C₁₀ α-olefin may be present in an amount of from about 5 wt %, or about 10 wt %, or 14 wt % to about 22 wt %, or about 25 wt % based on the total weight of the propylene-based elastomer. According to some embodiments, the comonomer-derived content is about from about 3 wt % to about 17 wt %, such as about 6 wt %, based on the total weight of the propylene-based elastomer. In at least one embodiment, the propylene-derived content is from about 83 wt % to about 97 wt %, based on the total weight of the propylene-based elastomer

In some embodiments, the comonomer content is adjusted so that the propylene-based elastomer having a heat of fusion of about 100 J/g or less, or about 75 J/g or less, a melting point (Tₘ) of about 100° C. or about 90° C. or less, and crystallinity of about 2% to about 65% of isotactic polypropylene, and a melt flow rate (“MFR”), as measured at 230° C. and 2.16 kg weight, of less than about 800 g/10 min.

In some embodiments, the propylene-based elastomer comprises more than one comonomer. In some embodiments the propylene-based elastomer has more than one comonomer including propylene-ethylene-octene, propylene-ethylene-hexene, and propylene-ethylene-butene copolymers. In embodiments where more than one comonomers derived from at least one of ethylene or a C₄ to C₁₀ α-olefins are present, the amount of each comonomer may be less than about 5 wt % of the propylene-based elastomer, but the combined amount of comonomers by weight of the propylene-based elastomer is about 5 wt % or greater. In some embodiments, the comonomer is ethylene, 1-hexene, or 1-octene, and in an amount of, e.g., from about 5 wt %, or about 1 wt %, or 14 wt % to about 22 wt %, or about 25 wt % based on the weight of the propylene-based elastomer.

In some embodiments, the propylene-based elastomer comprises ethylene-derived units. In some embodiments, the propylene-based elastomer comprises, e.g., from about 5 wt %, or about 10 wt %, or about 14 wt % to about 22 wt %, or about 25 wt % of ethylene-derived units by weight of the propylene-based elastomer. According to some embodiments, the propylene-based elastomer consists essentially of units derived from propylene and ethylene, i.e., the propylene-based elastomer does not contain any other comonomer in an amount typically present as impurities in the ethylene and/or propylene feedstreams used during polymerization or an amount that would materially affect the heat of fusion, melting point, crystallinity, or melt flow rate of the propylene-based elastomer, or any other comonomer intentionally added to the polymerization process.

In some embodiments, diene comonomer units are included in the propylene-based elastomer. Examples of the diene include, but not limited to, 5-ethylidene-2-norbornene, 5-vinyl-2-norbornene, divinylbenzene, 1,4-hexadiene, 5-methylene-2-norbornene, 1,6-octadiene, 5-methyl-1,4-hexadiene, 3,7-dimethyl-1,6-octadiene, 1,3-cyclopentadiene, 1,4-cyclohexadiene, dicyclopentadiene, or a combination thereof. In these embodiments, the amount of diene comonomer is equal to or more than about 0 wt %, or about 0.5 wt %, or about 1 wt %, or about 1.5 wt % and lower than, or equal to, about 5 wt %, or about 4 wt %, or about 3 wt % or about 2 wt % based on the weight of propylene-based elastomer.

In some embodiments, the propylene-based elastomer has a heat of fusion (“H_{f}”), as determined by DSC, of about 100 J/g or less, or about 75 J/g or less, about 70 J/g or less, about 50 J/g or less, or about 35 J/g or less. The propylene-based elastomer may have a lower limit H_{f} of about 0.5 J/g, about 1 J/g, or about 5 J/g. For example, the H_{f} value may be anywhere from about 1.0 J/g, about 1.5 J/g, about 3.0 J/g, about 4.0 J/g, about 6.0 J/g, or about 7.0 J/g, to about 30 J/g, about 35 J/g, about 40 J/g, about 50 J/g, about 60 J/g, about J/g 70, or about 75 J/g.

In some embodiments, the propylene-based elastomer has a percent crystallinity, as determined according to the DSC procedure described herein, of from about 2% to about 65%, such as from about 0.5% to about 40%, such as from about 1% to about 30%, such as from 5% to 35%, of isotactic polypropylene. The thermal energy for the highest order of propylene (i.e., 100% crystallinity) is estimated at about 189 J/g. In any embodiment, the propylene-based elastomer has a crystallinity in the range of from about 0.25% to about 25%, such as from about 0.5% to about 22% of isotactic polypropylene.

In some embodiments, the propylene-derived units of the propylene-based elastomer have an isotactic triad fraction of about 50% to about 99%, such as from about 65% to about 97%, such as from about 75% to about 97%. In other embodiments, the first polymer has a triad tacticity as measured by ¹³C NMR, of about 75% or greater, about 80% or greater, about 82% or greater, about 85% or greater, or about 90% or greater. The triad tacticity of a polymer is the relative tacticity of a sequence of three adjacent propylene units, a chain consisting of head to tail bonds, expressed as a binary combination of m and r sequences. It is usually expressed as the ratio of the number of units of the specified tacticity to all of the propylene triads in the first polymer. The triad tacticity (mm fraction) of a propylene-based elastomer can be determined from a ¹³C NMR spectrum of the propylene-based elastomer. The calculation of the triad tacticity is described in the U.S. Pat. No. 5,504,172, the entire contents of which are incorporated herein by reference.

In some embodiments, the propylene-based elastomer has a single peak melting transition as determined by DSC. In any embodiment, the propylene-based elastomer has a primary peak transition of about 90° C. or less, with a broad end-of-melt transition of about 110° C. or greater. The peak “melting point” (“Tₘ”) is defined as the temperature of the greatest heat absorption within the range of melting of the sample. However, the propylene-based elastomer may show secondary melting peaks adjacent to the principal peak, and/or at the end-of-melt transition. For the purposes of this disclosure, such secondary melting peaks are considered together as a single melting point, with the highest of these peaks being considered the Tₘ of the propylene-based elastomer. The propylene-based elastomer may have a Tₘ of about 100° C. or less, about 90° C. or less, about 80° C. or less, or about 70° C. or less. In any embodiment, the propylene-based elastomer has a Tₘ of from about 25° C. to about 100° C., such as from about 25° C. to about 85° C., such as from about 25° C. to about 75° C., such as from about 25° C. to about 65° C. In any embodiment, the propylene-based elastomer has a Tₘ of about 30° C. to about 80° C., such as from about 30° C. to about 70° C.

For the thermal properties of the propylene-based elastomers, Differential Scanning calorimetry (“DSC”) was used. Such DSC data was obtained using a Perkin-Elmer DSC 7.5 mg to 10 mg of a sheet of the polymer to be tested was pressed at approximately 200° C. to 230° C., then removed with a punch die and annealed at room temperature for 48 hours. The samples were then sealed in aluminum sample pans. The DSC data was recorded by first cooling the sample to −50° C. and then gradually heating it to 200° C. at a rate of 10° C./minute. The sample was kept at 200° C. for 5 minutes before a second cooling-heating cycle was applied. Both the first and second cycle thermal events were recorded. Areas under the melting curves were measured and used to determine the heat of fusion and the degree of crystallinity. The percent crystallinity (X%) was calculated using the formula, X%=[area under the curve (Joules/gram)/B(Joules/gram)]*100, where B is the heat of fusion for the homopolymer of the major monomer component. These values for B were found from the Polymer Handbook, Fourth Edition, published by John Wiley and Sons, New York 1999. A value of 189 J/g (B) was used as the heat of fusion for 100% crystalline polypropylene. The melting temperature was measured and reported during the second heating cycle (or second melt).

In one or more embodiments, the propylene-based elastomer has a Mooney viscosity [ML (1+4)@125° C.], as determined according to ASTM D-1646, of less than about 100, in other embodiments less than about 75, in other embodiments less than about 60, and in other embodiments less than 30.

In some embodiments, the propylene-based elastomer has a melt viscosity, measured according to method ASTM D-3236 at 190° C., of less than about 15,000 mPa·s, such as less than about 10,000 mPa·s.

In some embodiments, the propylene-based elastomer has a density of from about 0.850 g/cm³ to about 0.920 g/cm³, such as from about 0.860 g/cm³ to about 0.900 g/cm³, such as from about 0.860 g/cm³ to about 0.890 g/cm³, at room temperature as measured per ASTM D-1505. In some embodiments, the propylene-based elastomer has a density of 0.879 g/cm³.

In some embodiments, the propylene-based elastomer has a melt flow rate (“MFR”) greater than about 0.5 g/10 min, and less than or equal to about 1,000 g/10 min, or less than or equal to about 800 g/10 min, such as less than or equal to about 500 g/10 min, such as less than or equal to about 200 g/10 min, such as less than or equal to about 100 g/10 min, such as less than or equal to about 50 g/10 min. In some embodiments, the propylene-based elastomer has an MFR of less than or equal to about 25 g/10 min, such as from about 1 g/10 min to about 25 g/10 min, such as from about 1 g/10 min to about 20 g/10 min. The MFR is determined according to ASTM D-1238, condition L (2.16 kg, 230° C.).

In some embodiments, the propylene-based elastomer has a weight average molecular weight (“Mw”) less than about 100,000 g/mol, such as less than about 50,000 g/mol, such as from about 5,000 g/mol to about 50,000 g/mol, such as from about 28,000 g/mol to about 40,000 g/mol.

In some embodiments, the propylene-based elastomer has a number average molecular weight (“Mn”) of from about 2,500 g/mol to about 2,500,00 g/mol, such as from about 10,000 g/mol to about 250,000 g/mol, such as from about 25,000 g/mol to about 200,000 g/mol.

In some embodiments, the propylene-based elastomer has a z-average molecular weight (“Mz”) of from about 10,000 g/mol to about 7,000,000 g/mol, such as from about 80,000 g/mol to about 700,000 g/mol, such as from about 100,000 g/mol to about 500,000 g/mol.

In some embodiments, the propylene-based elastomer has a The propylene-based elastomer may have a molecular weight distribution (Mw/Mn, or “MWD”) of from about 1.5 to about 20, such as from about 1.5 to about 15, such as from about 1.5 to about 5, such as from about 1.8 to about 5, such as from about 1.8 to about 4.

In some embodiments, the propylene-based elastomer has an Elongation at Break of less than about 2000%, less than about 1000%, or less than about 800%, as measured per ASTM D412. In some embodiments, the elongation at break is about 1237%.

In some embodiments, the propylene-based elastomer has a durometer hardness (Shore) of from 60 Shore D to about 60 Shore A. In some embodiments, the durometer hardness is 53 Shore C.

Commercial examples of such propylene-based elastomers includes Vistamaxx™ propylene-based elastomers from ExxonMobil Chemical Company, Tafmer™ elastomers from Mitsui Chemicals, and Versify™ elastomers from Dow Chemical Company.

### Polyolefin Wax

The adhesive compositions include a polyolefin wax. Specifically, the adhesive compositions include a polyethylene wax and, optionally, a polypropylene wax. Polyethylene waxes include polyethylene homopolymers and ethylene copolymers. Polypropylene waxes include both homo-polypropylenes and propylene copolymers.

In some embodiments, the polyolefin wax(es) is produced by thermal degradation of high molecular weight branched polyolefin polymers or by direct polymerization of olefins. Suitable polymerization processes include, for example, high-pressure technologies, in which the olefins, generally ethylene, are reacted free-radically under high pressures and temperatures to form branched waxes, and also low-pressure or Ziegler processes, in which ethylene and/or higher 1-olefins are polymerized using organometallic catalysts. Polyethylene waxes produced using metallocene catalyst have a narrower molecular weight distribution, more uniform incorporation of comonomer, and lower melting points, in comparison to the Ziegler-Natta technology.

In some embodiments, the polyolefin wax(es) has a weight average molecular weight (Mw) of from about 500 g/mol to about 30,000 g/mol, such as from about 1,000 g/mol to about 30,000 g/mol, such as from about 6,000 g/mol to about 25,000 g/mol, such as from about 10,000 g/mol to about 20,000 g/mol. In some embodiments, the polyolefin wax(es) has a Mw of about 1,100, or about 2,500, or about 5,200, or about 6,500, or about 14,000, or about 24,000, or about 25,000.

In some embodiments, the polyolefin wax(es) has a Mw/Mn (or PDI) of from about 1 to about 10, such as from about 1.3 to about 5, such as from about 1.5 to about 5, such as from about 2 to about 5. In some embodiments, the polyolefin wax has a Mw/Mn of about 1.1, about 1.3, about 1.9, about 2.2, about 2.4, about 2.9, about 3.2, or about 3.7.

In some embodiments, the polyolefin wax(es) has a density of greater than 0.9 g/cm³, such as from about 0.9 g/cm³ to about 0.98 g/cm³, such as from about 0.9 g/cm³ to about 0.97 g/cm³, such as from about 0.94 g/cm³ to about 0.97 g/cm³. In some embodiments, the polyolefin wax(es) has a density of greater than about 0.94 g/cm³, such as greater than about 0.95 g/cm³, such as from about 0.95 g/cm³to about 0.98 g/cm³. In some embodiments, the polyolefin wax(es) is a high density polyethylene (HDPE) wax. HDPE has a density of greater than about 0.940 g/cm³.

In some embodiments, the polyolefin wax(es) has a crystallization temperature of 90° C. or more, such as about 100° C. or more, such as about 110° C. or more, such as about 115° C. In some embodiments, the crystallization temperature is less than about 120° C. In some embodiments, the crystallization temperature of the polyolefin wax(es) is higher than that of the propylene-based elastomer. A high crystallization temperature relative to that of the neat propylene-based elastomer can facilitate earlier crystallization of the propylene-based elastomer upon rapid cooling from the melt. The polyolefin wax component(s) increase the crystallization temperature of the propylene-based elastomer in the melt of adhesive relative to the neat propylene-based elastomer by itself, for example, by providing nucleation sites for propylene-based elastomer crystallization. The crystallization temperature of the polyolefin wax component(s) and propylene-based elastomer can be determined either neat or in a blend by differential scanning calorimetry (DSC), according to ASTM D3418-03. The crystallization curve of the propylene-based elastomer shifts when the DSC data are collected for the adhesive composition containing a small amount of polyolefin wax(es), e.g., the propylene-based elastomer crystallizes from the melt of adhesive at a higher temperature than the neat propylene-based elastomer.

In some embodiments, the polyolefin wax(es) has a crystallinity, as measured by X-ray diffraction, of greater than about 40%, such as greater than about 60%, such as about 81% or about 82%. In some embodiments, the polyolefin wax(es) has a crystallinity, as measured by X-ray diffraction, of about 47%

In some embodiments, the polyolefin wax(es) has a weight average molecular weight that is sufficient to inhibit migration to the interface of the adhesive with the substrate, which can weaken the interfacial bonding. In some embodiments, the weight average molecular weight (Mw) of the wax is 2,500 g/mol or more. In some embodiments, the ratio of the weight average molecular weight of the polyolefin wax component(s) to that of the propylene-based elastomer is at least about 0.08, such as at least about 0.10, such as at least about 0.15, such as at least about 0.20, such as at least about 0.3, such as at least about 0.4, such as at least about 0.5. In some embodiments, the ratio of the weight average molecular weight of the polyolefin wax component(s) to that of the propylene-based elastomer is 1.5 or less, 1.25 or less, 1.0 or less, 0.8, or less, 0.6 or less, 0.4 or less, 0.20 or less, 0.15 or less, and 0.10 or less. In still another embodiment, the range of ratios of the weight average molecular weight of the wax component(s) to that of the base copolymer is from 0.15 to 1.5, 0.15 to 0.5.

In some embodiments, the neat wax has a viscosity at 190° C. of at least about 50 mPa·s, such as at least about 100 mPa·s. In at least one embodiment, the polyolefin wax has a viscosity at 190° C. of less than about 3000 mPa·s, such as less than about 2000 mPa·s, such as less than about 1000 mPa·s.

In some embodiments that include more than one polyolefin wax (e.g., a first polyolefin wax and second polyolefin wax), the crystallization temperature of the second polyolefin wax may be higher than the crystallization temperature of the propylene-based elastomer, as determined by differential scanning calorimetry (DSC) according to ASTM D3418-03, such that the second polyolefin wax solidifies first and acts as a nucleating agent for the propylene-based elastomer in the adhesive composition.

In some embodiments, the polyolefin wax is a polyethylene wax having an Mw of from about 2,000 g/mol to about 20,000 g/mol, a molecular weight distribution Mw/Mn, which is also referred to as the polydispersity index, of from about 2 to 10, a viscosity at 190° C. of from 50 to 1000 mPa·s, a melting temperature range of from about 120° C. to 131° C. for a homopolymer and from about 100° C. to 126° C. for a copolymer, and a density of from 0.90 to 0.97 g/cm³. Examples of low molecular weight polyethylene waxes that are commercially available include Licowax™ and Licocene™ from Clariant, Petrolite™ C-4040 and Polywax™ 1000, 2000, and 3000 from Baker Petrolite Corporation (Sugarland, Tex.); low molecular weight by-product polyethylene waxes under the trade designation Marcus™ 100, 200, and 300, from Marcus Chemical Co., a Division of H.R.D. Corp. (Houston, Tex.); are also available commercially from Honeywell Corporation, or Eastman Corporation.

### Tackifier

The adhesive compositions include a polyolefin wax. Examples of suitable tackifiers, include aliphatic hydrocarbon resins, aromatic modified aliphatic hydrocarbon resins, cyclopentadiene resins, hydrogenated polycyclopentadiene resins, polycyclopentadiene resins, gum rosins, gum rosin esters, wood rosins, wood rosin esters, tall oil rosins, tall oil rosin esters, polyterpenes, aromatic modified polyterpenes, terpene phenolics, aromatic modified hydrogenated polycyclopentadiene resins, hydrogenated aliphatic hydrocarbon resins, hydrogenated aliphatic aromatic resins, aromatic hydrocarbon resin, hydrogenated aromatic hydrocarbon resins, cycloaliphatic hydrocarbon resins, hydrogenated cycloaliphatic hydrocarbon resins, terpene-phenol resins, hydrogenated terpenes and modified terpenes, rosin acid resins, hydrogenated rosin acids, rosin ester resins, and hydrogenated rosin esters. In some embodiments the tackifier is hydrogenated. In some embodiments, the adhesive composition includes a combination of tackifiers.

In some embodiments, the tackifier is non-polar, by which is meant that the tackifier is substantially free of monomers having polar groups. In some embodiments, the polar groups are not present, however if present, the polar groups comprise not more than about 5 wt %, such as about 2 wt % or less, such as about 0.5 wt % or less, of the tackifier. In some embodiments, the tackifier has a softening point (Ring and Ball, as measured by ASTM E-28) of about 80° C. to about 150° C., such as about 100° C. to about 130° C. In some embodiments, the tackifier is liquid and has a ring and ball softening point of from about 10° C. and about 70° C.

Examples of hydrocarbon resins for use as tackifiers or modifiers include:

(a) Resins such as C5/C6 terpene resins, styrene terpenes, alpha-methyl styrene terpene resins, C9 terpene resins, aromatic modified C5/C6, aromatic modified cyclic resins, aromatic modified dicyclopentadiene based resins or mixtures thereof. Additional resins include those described in WO 91/07472, U.S. Pat. Nos. 5,571,867, 5,171,793 and 4,078,132. Typically these resins are obtained from the cationic polymerization of compositions containing one or more of the following monomers: C5 diolefins (such as 1-3 pentadiene, isoprene, etc.); C5 olefins (such as 2-methylbutenes, cyclopentene, etc.); C6 olefins (such as hexene), C9 vinylaromatics (such as styrene, alpha methyl styrene, vinyltoluene, indene, methyl indene, etc.); cyclics (such as dicyclopentadiene, methyldicyclopentadiene, etc.); and or terpenes (such as limonene, carene, etc).

(b) Resins obtained by the thermal polymerization of dicyclopentadiene, and/or the thermal polymerization of dimers or oligomers of cyclopentadiene and/or methylcyclopentadiene, optionally with vinylaromatics (such as styrene, alpha-methyl styrene, vinyl toluene, indene, methyl indene).

In some embodiments, the hydrocarbon resin has a total dicyclopentadiene, cyclopentadiene, and methylcyclopentadiene derived content of from about 60 wt % to about 100 wt % of the total weight of the hydrocarbon resin and wherein the hydrocarbon resin has a weight average molecular weight of from 600 g/mol to 1400 g/mol.

Suitable commercially available tackifiers include Escorez™ 1000, 2000 and 5000 series hydrocarbon resins, ECR-373, Oppera™ PR 100, 101, 102, 103, 104, 105, 106, 111, 112, 115, and 120, available from ExxonMobil Chemical Company, Arkon™ M series, Arkon™ P series, and Super Ester™ rosin esters available from Arakawa Chemical Company of Japan, Sylvares™ phenol modified styrene-α methyl styrene resins, styrenated terpene resins, Zonatac™ terpene-aromatic resins, and terpene phenolic resins available from Arizona Chemical Company of Jacksonville, Fla., Sylvatac™ and Sylvalite™ rosin esters available from Arizona Chemical Company, Norsolene™ aliphatic aromatic resins available from Cray Valley of France, Dertophene™ terpene phenolic resins available from DRT Chemical Company of Landes, France, Eastotac™ resins, Piccotac™ C5/C9 resins, Regalite™ and Regalrez™ aromatic, and Regalite™ cycloaliphatic/aromatic resins available from Eastman Chemical Company of Kingsport, Term., Wingtackt™ resins available from Goodyear Chemical Company of Akron, Ohio, Foral™, Pentalyn™, and Permalyn™ rosins and rosin esters available from Eastman Chemical Company, Quintone™ acid modified C5 resins, C5/C9 resins, and acid modified C5/C9 resins available from Nippon Zeon of Japan, and LX™ mixed aromatic/cycloaliphatic resins available from Neville Chemical Company of Pittsburgh, Pa., Clearon™ hydrogenated terpene aromatic resins available from Yasuhara Chemical of Japan. The preceding examples are illustrative only and by no means limiting.

### Amounts of the Components

The adhesive composition includes at least a propylene-based elastomer, a polyethylene wax, and a tackifier. Optional components of the adhesive composition include a polypropylene wax.

In some embodiments, the amount of propylene-based elastomer in the adhesive composition is from about 65 wt % to about 99 wt %, such as from about 65 wt % to about 97 wt %, such as from about 65 wt % to about 95 wt %, such as from about 70 wt % to about 80 wt %, based on the total weight of the adhesive composition.

In some embodiments, the amount of polyethylene wax in the adhesive composition is from about 1 wt % to about 35 wt %, such as from about 1 wt % to about 25 wt %, such as from about 5 wt % to about 15 wt %, based on the total weight of the adhesive composition. In at least one embodiment, the amount of polyethylene wax in the adhesive composition is about 3 wt % or about 10 wt % based on the total weight of the adhesive composition.

In some embodiments, the amount of tackifier is from about 0.1 wt % to about 34 wt %, such as from about 1 wt % to about 34 wt %, such as from about 5 wt % to about 34 wt %, such as from about 5 wt % to about 15 wt %, for example about 10 wt %, based on the total weight of the adhesive composition. In some embodiments, the amount tackifier, if present in the adhesive composition, is from about 2 wt % to about 10 wt %, for example about 3 wt % to about 5 wt %, based on the total weight of the adhesive composition.

In some embodiments, the amount of polypropylene wax is from about 0 wt % to about 20 wt %, such as from about 0.5 wt % to about 20 wt %, such as from about 1 wt % to about 15 wt %, for example about 1 wt %, 3 wt %, 5 wt %, 10 wt %, and 15 wt %, based on the total weight of the adhesive composition.

In an embodiment, an adhesive composition includes (a) a propylene-based elastomer comprising at least about 60 wt % of propylene and from about 2 wt % to about 40 wt % of a C₂ and/or a C₄-C₂₀ α-olefin based on a total weight of the propylene-based elastomer, and having a melting temperature of less than about 110° C., a heat of fusion of less than about 75 J/g, and an average molecular weight (Mw) of less than about 100,000 g/mol; (b) a polyethylene wax having a density of less than about 0.940 g/cm³, an average molecular weight (Mw) of from about 3,000 g/mol to about 30,000 g/mol, and a crystallization temperature of greater than about 100° C.; (c) a tackifier; and (d) optionally a polypropylene wax.

In another embodiment, an adhesive composition includes about 70 wt % to about 80 wt % of a propylene-based elastomer based on a total weight of the adhesive composition; about 10 wt % of a polyethylene wax based on a total weight of the adhesive composition; about 0 wt % to about 10 wt % of a polypropylene wax based on a total weight of the adhesive composition; and about 0.1 wt % to about 10 wt % of a tackifier based on a total weight of the adhesive composition.

### Properties of the Adhesive Composition

In some embodiments, the adhesive composition is substantially free of a functionalized polyolefin.

In some embodiments, the adhesive composition has a crystallization temperature of greater than about 70° C. In some embodiments, the adhesive composition exhibits at least two peaks when subjected to DSC cooling, with a first (highest) crystallization point (T_{c}) of at least 90° C., corresponding to a crystallization of the high-crystallization-temperature wax component(s), and at least a second crystallization point of at least 40° C. The difference between the first and second crystallization temperatures in one embodiment is at least about 20° C. All the crystallization temperatures of the wax components and propylene-based elastomer can be determined either neat or in a blend by the DSC procedure, provided below, according to ASTM D 3418-03.

As discussed herein, the crystallization curve of the propylene-based elastomer shifts when the DSC data are collected for the adhesive composition containing a small amount of polyolefin wax(es), e.g., the propylene-based elastomer crystallizes from the melt of adhesive at a higher temperature than the neat propylene-based elastomer. In some embodiments, the high-crystallization-temperature polyolefin wax(es) is the first ingredient to solidify as the molten adhesive cools. The order of crystallization among the components in the adhesive upon cooling can be determined using DSC. In some embodiment, there exists a crystallization peak in a DSC trace where the first crystallization temperature is about the same as the crystallization temperature of the neat high-crystallization-temperature wax component(s), e.g. within about 5° C. or about 10° C., and the second crystallization temperature (corresponding to a propylene-based elastomer component) is higher than that of the neat propylene-based elastomer by at least about 5° C., such as about 10° C. or more.

In some embodiments, the adhesive composition has an elongation at break, measured according to method ISO 37, of greater than about 150%.

In some embodiments, the adhesive composition has a set time of about 2.5 seconds or less, such as about 2.2 seconds or less, such as about 2 seconds or less, such as about 1.7 seconds or less, such as about 1.5 seconds or less, such as about 1.25 seconds or less, as determined by auto set time machine, set time is defined as the duration when more than 75% fiber tear observed. In some embodiments, the adhesive composition has a set time greater than about 1 second, such as from 1 second to about 3 seconds, such as from about 1.25 seconds to about 2.25 seconds.

In some embodiments, the adhesive composition has a ΔT_{c} of 10° C. or more, such as from about 10° C. to about 30° C., such as from about 10° C. to about 25° C., such as from about 20° C. to about 25° C., wherein ΔT_{c} is defined as the difference between the crystallization temperature of the neat propylene-based elastomer and the crystallization temperature of the propylene-based elastomer and the wax(es).

In some embodiments, the adhesive composition has a crystallization window of from 50° C. to about 120° C.

In some embodiments, the difference between the melting and crystallization peak temperatures (Tₘ−T_{c}) of the adhesive composition, i.e., the supercooling range, is less than about 40° C., such as less than about 30° C., such as less than about 20° C. Where there are multiple crystallization peaks in the adhesive composition, the highest peak crystallization temperature is used for the supercooling calculation.

### Experimental

Peak melting point, Tₘ, (also referred to as melting point), peak crystallization temperature, T_{c}, (also referred to as crystallization temperature), glass transition temperature (Tg), heat of fusion (ΔHf or Hf), and percent crystallinity were determined using the differential scanning calorimetric (DSC) procedure discussed in U.S. Pat. No. 8,283,400 according to ASTM D3418-03. DSC data were obtained using a TA Instruments model Q100 machine.

Polarizing Optical Microscopy (POM) with hot stage was used to study the crystal morphology during the cooling process. The samples are heated to 200° C. as quickly as possible and then cooled down at a rate of 10° C./min on a hot stage while taking photos.

Storage modulus (G′) was determined using a rotational rheometer, Advanced Rheometric Expansion System, in temperature ramp when cooling down from high temperature at 10° C./min.

Set time (also referred to as characteristic set time or dot set time) is defined as the minimum time required for a compressed adhesive substrate assembly to fasten together enough to give substrate fiber tear when pulled apart, and thus the bond is sufficiently strong to remove the compression. For the following procedure, the adhesive was melted in a beaker at 200° C. The set times are measured by trial and error by placing a molten long bead of adhesive on to a Kraft paper substrate (6 cm×15 cm, width by length) taped to a flat table. Another piece of Kraft paper substrate is immediately placed upon the molten long bead of adhesive and compressed with a 500-gram weight. The weight is allowed to sit for a predetermined time period from about 0.5 seconds to about 10 seconds. The construct thus formed is then pulled apart. The procedure is repeated for several assemblies, holding the compression for different periods for each assembly. The minimum time required tear the paper is recorded as the set time. Standard adhesive formulas are used to calibrate the process.

Table 1 lists thermal properties and molecular weights of commercial waxes used for the example and comparative formulations.

TABLE 1

| Wax | Type | Tₘ/T_{c} (° C.) | Mw (g/mol) | Mw/Mn |
|---|---|---|---|---|
| Epolene ™ C15 | LDPE | 93/78 | 31,000 | 3.2 |
| Mitsui ™ 800P | HDPE | 129/115 | 14,000 | 2.9 |
| Polywax ™ 2000 | HDPE | 124/110 | 2,500 | 1.1 |
| Licocene ™ PE5301 | mPE | 128/115 | 5,200 | 2.2 |
| Sasolwax ™ H1 | FT | 109/98, 89/81 | 1,100 | 1.3 |
| Epolene ™ N15 | PP | 157/109 | 25,000 | 3.7 |
| Licocene ™ PP6102 | mPP | 129/96 | 6,500 | 1.9 |
| Licocene ™ PP7502 | mPP | 150/110 | 24,000 | 2.4 |

Epolene™ C15 polyethylene (PE) wax is low density polyethylene wax available from Westlake Company. Mitsui™ 800P is a high density polyethylene wax available from Mitsui Co. Ltd. Polywax™ 2000 is a high density polyethylene wax available from Baker Petrolite. Licocene™ PE5301 is a metallocene-catalyzed polyethylene (mPE) based wax available from Clariant. Sasolwax™ H1 is a Fischer-Tropsch (FT) polyethylene wax available from Sasol Company. Epolene™ N15 polypropylene (PP) wax is available from Westlake Company. Licocene™ PP6102 is a metallocene-catalyzed polypropylene (mPP) based wax available from Clariant. Licocene™ PP7502 is a mPP based wax available from Clariant. Vistamaxx™ 8880 is a propylene-based elastomer available from ExxonMobil Chemical Company having a C2 content of 6 wt %, a density of 0.879 g/cm³, a melt viscosity@190° C. (ASTM D-3236) of 1200 mPa·s. Escorez™ 5600 is a tackifier available from ExxonMobil Chemical Company. Advantra™ 9256 is an adhesive composition available from H.B. Fuller.

### Performance Using Wax

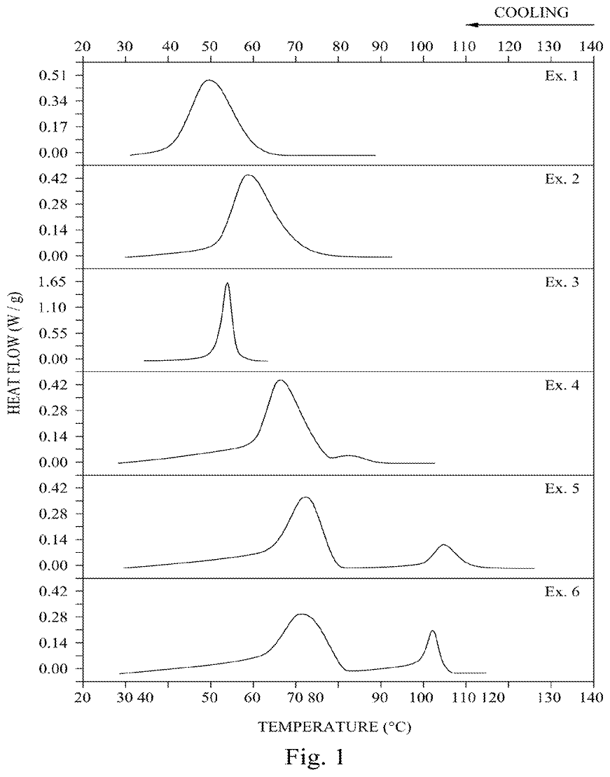

The seven commercial waxes were combined individually with Vistamaxx™ 8880 and studied by DSC. Samples were prepared by mixing 3 wt % of the commercial wax and 97 wt % of Vistamaxx™ 8880. Results are shown in FIGS. 1-3.

Example 1 is Vistamaxx™ 8880. Example 2 is Vistamaxx™ 8880 and PP6102. Example 3 is Vistamaxx™ 8880 and C15. Example 4 is Vistamaxx™ 8880 and Sasol H1. Example 5 is Vistamaxx™ 8880 and Mitsui 800P. Example 6 is Vistamaxx™ 8880 and Polywax 2000. Example 7 is Vistamaxx™ 8880 and PE5301.

FIG. 1 shows crystallization curves during the cooling process. The position of the crystallization temperature (T_{c}) peak was at 50° C. for neat Vistamaxx™ 8880 and shifted to higher T_{c} upon addition of a wax. The shift in T_{c} to higher temperatures indicated an earlier onset of the crystallization process when adding wax. The adhesive compositions—Examples 5 and 6—that include the high density polyethylene waxes Mitsui 800P and Polywax 2000, respectively, had the highest T_{c} values and therefore crystallized more quickly than the other polyethylene waxes (e.g., LDPE, mPE, and FT) and polypropylene waxes. The higher T_{c} values indicate that the adhesive compositions crystallized more quickly than the other polyethylene waxes.

Two T_{c} peaks were observed with the adhesive compositions that included the HDPE waxes (Examples 5 and 6). This is likely due to phase separation, whereby when cooling down the HDPE wax crystallized first (the higher Tc peak), and then—due to the presence of the wax crystalline network—Vistamaxx™ 8880 started to crystallize.

The data also indicate that linear polyethylene waxes (e.g., Mitsui 800P, Polywax 2000 and PE 5301) result in a greater shift of the T_{c} value of the propylene-based elastomer and also enhance the crystallization process. For example, Epolene™ C15 is a branched PE wax associated with a shift in the T_{c} of about 5° C., whereas Mitsui™ 800P, Polywax™ 2000, and Licocene™ PE5301 are all highly linear polyethylene waxes and each associated with a shift in the T_{c} of about 20-25° C.

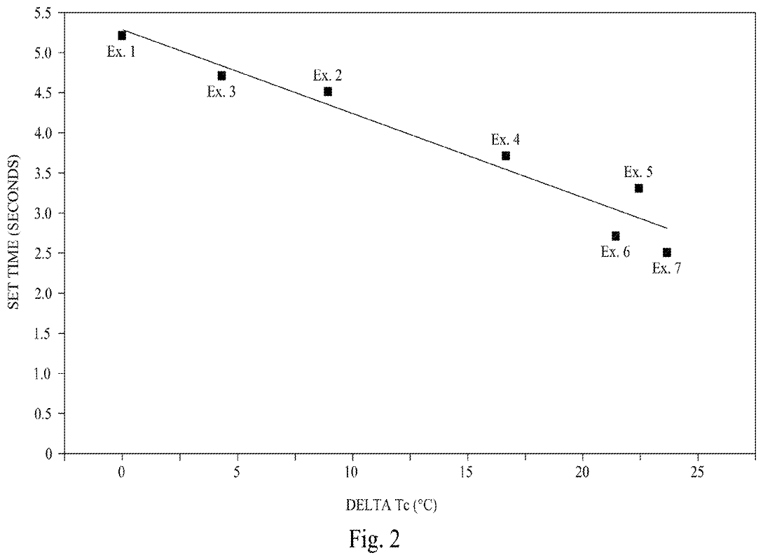

FIG. 2 shows that the addition of polyolefin waxes shift the T_{c} peak relative to that of neat Vistamaxx™ 8880, with the HDPE waxes associated with a shift to around 70° C. The distance between original T_{c} position of neat Vistamaxx™ 8880 and the T_{c} of the Vistamaxx™ 8880 with wax is defined as delta T_{c} (ΔT_{c}). The highest ΔT_{c} value demonstrates the earliest crystallization upon cooling, which will lead to the fastest set time. ΔT_{c} and set time were plotted as shown in FIG. 2. The correlation is nearly linear, indicating that as ΔT_{c} increase, set time becomes faster (decreases). Vistamaxx™ 8880 blended with HDPE waxes achieved the fastest set time.

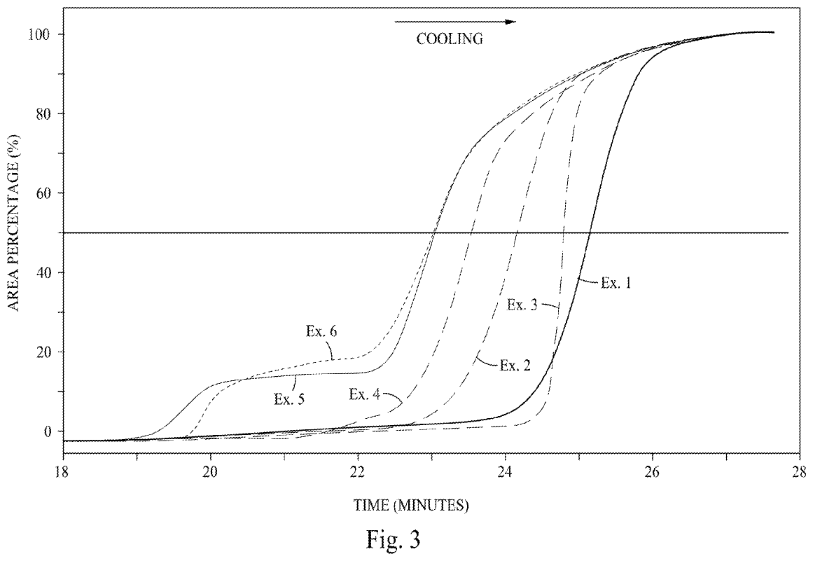

A faster (shorter) set time is due not only to earlier onset of crystallization, but also to the rate of crystallization. Area percentage curves shown in FIG. 3 were calculated by integrating the crystallization peaks, allowing comparison of the time from crystallinity initiation to completion in each of the samples. Shorter times to reach 50% crystallinity (smaller to t_{0.5} or t_{half}) indicates faster crystal growth. According to FIG. 3, compositions that include an HDPE wax (Polywax 2000 or Mitsui 800P) with Vistamaxx™ 8880 have the smallest t_{0.5} and are the quickest to crystallize.

Polarizing optical microscopy, POM, was used to image the crystalline growth process of the adhesive compositions including the propylene-based elastomer and the polyolefin wax. Example 1 (neat Vistamaxx™ 8880) was compared to Example 6 (Vistamaxx™ 8880+Polywax 2000). For Example 1, the crystals of Vistamaxx™ 8880 started to appear near 72° C., and completed about 50% crystallization around 49° C. The morphology at room temperature of Example 1 appeared homogeneous as compared to the morphology at room temperature of Example 6. For Example 6, the crystals of Polywax 2000 initiated much earlier than neat Vistamaxx™ 8880. At 105° C., many crystals were detected by POM, and the crystals grew quickly. A photograph was captured at 76° C. temperature, the temperature corresponding to t_{0.5}. In Example 6, the Vistamaxx™ 8880 component crystallized later than wax component, and the Vistamaxx™ 8880 crystals grew upon and/or around the existing wax crystals, which introduced a crystal interaction effect and lead to a less homogeneous morphology than neat Vistamaxx™ 8880 at about room temperature. Blending Vistamaxx™ 8880 with other HDPE waxes showed similar processes, morphologies, and quick response during cooling. The linear molecular structure of the HDPE wax imparted faster crystallization and higher crystallinity to the wax, and worked as a nucleating agent for Vistamaxx™ 8880 by helping to accelerate the start of (and rate of) crystallization for Vistamaxx™ 8880, and in turn, lead to faster set times for packaging adhesive applications.

Neat Vistamaxx™ 8880 has low viscosity and a relatively high crystallinity for propylene-based elastomers. As shown herein, the performance tests conducted to correlate crystallization properties and set time highlight that polyolefin waxes (e.g., PE and PP waxes) enhance the solidification process of propylene-based elastomers (e.g., Vistamaxx™ 8880). With only 3% addition of HDPE wax accelerates solidification process during cooling, which is required as a good hot melt adhesive because fast set time will improve the efficiency of production line for packaging applications.

### Performance Using Wax and Tackifier

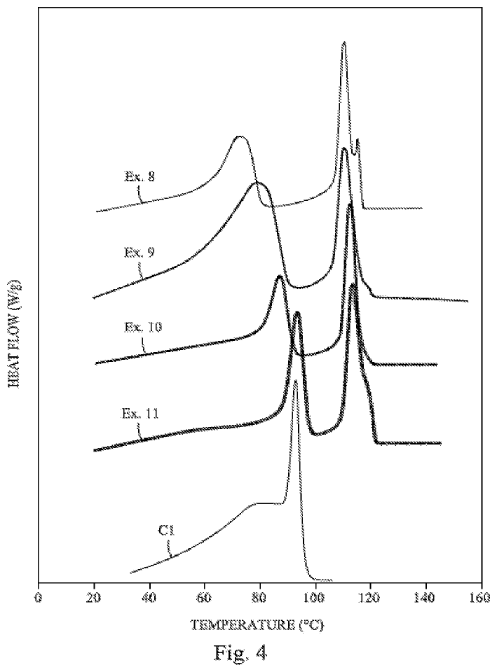

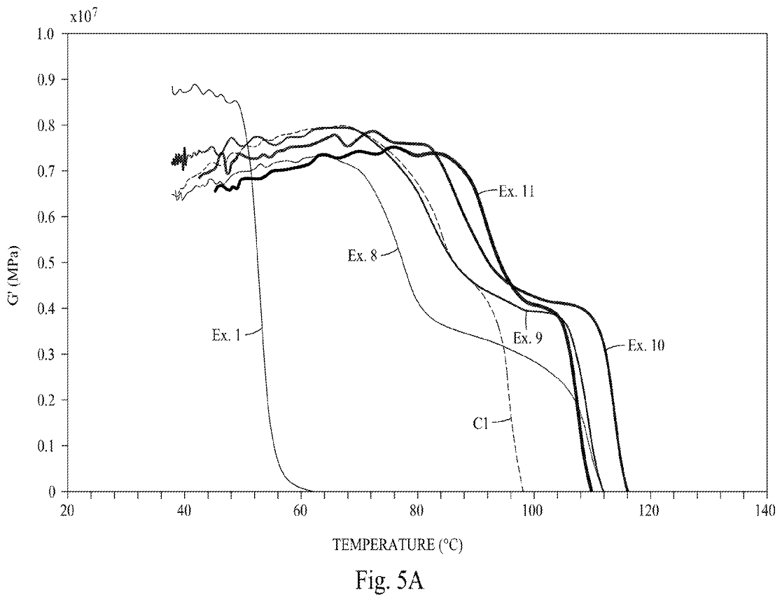

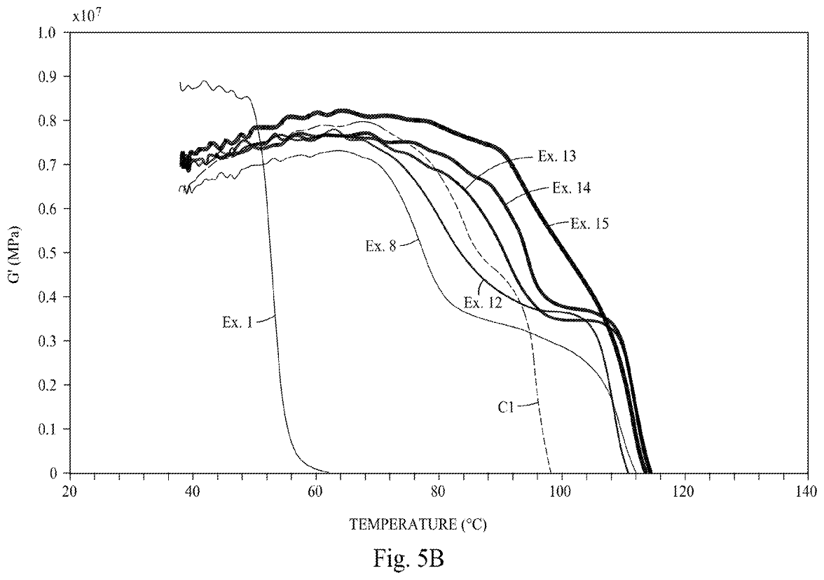

Adhesive compositions Examples 8-15 were made by overhead stirring. The comparative adhesive composition, C1, was Advantra™ 9256, which includes a tackifier and a wax. The ingredients, and amounts (wt %) thereof, for the example and comparative adhesive compositions are provided in Table 2. Thermal and rheological behaviors of the adhesive compositions are shown in FIGS. 4, 5A, and 5B.

TABLE 2
Adhesive Compositions (in Wt %) & Properties

| | Ex. 8 | Ex. 9 | Ex. 10 | Ex. 11 | Ex. 12 | Ex. 13 | Ex. 14 | Ex. 15 | C1^{‡} |
|---|---|---|---|---|---|---|---|---|---|
| Vistamaxx ™ 8880 | 80 | 75 | 70 | 65 | 79 | 77 | 75 | 70 | |
| Escorez ™ 5600 | 10 | 10 | 10 | 10 | 10 | 10 | 10 | 10 | |
| Mitsui ™ 800P | 10 | 10 | 10 | 10 | 10 | 10 | 10 | 10 | |
| Licocene ™ PP6102 | — | 5 | 10 | 15 | — | — | — | — | |
| Licocene ™ PP7502 | — | — | — | — | 1 | 3 | 5 | 10 | |
| Set time (seconds) | 2.2 | 1.7 | 1.5 | 1.5 | 2.1 | 1.7 | 1.5 | 1.25 | 1.7 |
| Flexibility | Ductile | Soft | Soft | Soft | Ductile | Ductile | Ductile | Ductile | Soft |

^{‡}C1 is Advantra ™ 9256.

The tackifier component improves flow of the hot melt adhesive, allowing the adhesive to flow smoothly onto surfaces. The wax affects the crystallization process, enabling the hot melt adhesive to rapidly cool to a tough, adherent solid bond at room temperature. Adding an ethylene wax achieves fast set time but poor cohesion, because PE wax has higher crystallization temperature and works as a nucleating agent to accelerate the Vistamaxx™ polymer crystallization process. However, incompatibility with Vistamaxx™ polymer, which is composed predominantly of propylene, leads to heterogeneous morphology and poor mechanical performance, so PP wax is also added to increase the compatibility.

Among these waxes, Mitsui 800P best balances the set time and cohesion property. It has a higher crystallization temperature (leading to fast set time), and a higher molecular weight than the other HDPE waxes. The long entangled chains will more likely generate radial crystallization, as tie chains may be formed to connect the lamellar-amorphous phase, and its spherulitic nucleation sites enables faster Vistamaxx™ polymer crystallization. These crystallization mechanisms may improve the ductility and flex properties of the adhesive blend including Mitsui™ 800P, leading to better cohesive strength as compared to blends including other HDPE waxes.

Crystallization temperature (T_{c}) peaks of hot melt adhesive formulations composed of Vistamaxx™ 8880, 10% Escorez™ 5600, and 10% Mitsui™ 800P with increasing amounts of Licocene™ PP6102 content (Examples 8-11) are shown in FIG. 4. Each of the Examples 9-11 has the same or shorter set time as the comparative C1. Additionally, the novel adhesive compositions Examples 8-11 have a higher T_{c} with increasing amounts of Licocene™ PP6102 content, and high T_{c} and sharp T_{c} peaks indicative of quick creation of a crystalline network with good cohesion, even at a high cooling rate.

FIGS. 5A and 5B provide information on the rheology of the adhesive compositions. The rheology curves show that the novel adhesive compositions disclosed herein start the solidification process earlier than Advantra™ with narrow crystallization breadth. For packaging applications, it is desired for hot melt adhesives to have G′ (storage modulus) values at room temperature in the range of about 10⁶ MPa to about 10⁷ MPa. If G′ value is higher than 10⁹ MPa, the hot melt adhesive is very brittle and results in adhesive failure or cohesive failure. However, in the G′ range of from 10⁶ MPa to about 10⁷ MPa, a higher G′ leads to better cohesive strength and indicates good mechanical performance. This study shows that addition of a propylene wax, such as Licocene™ PP6102 or Licocene™ PP7502, to adhesive compositions may raise the G′ value of propylene-based elastomers.

The data show improvement in set times and elongation over conventional adhesive compositions that include 30 wt % to 60 wt % ethylene and octane-1 copolymer, 30 wt % to about 60 wt % hydrogenated hydrocarbon resin tackifier, and 30 wt % to 60 wt % paraffin wax.

The compositions described herein provide an alternative and more robust material for hot melt adhesive compositions. The examples show that compositions containing low viscosity propylene-based elastomer (e.g., Vistamaxx™ 8880) have low set time, good bonding strength, good cohesive strength, good fiber tear value, and low viscosity. Moreover, these compositions performed better than conventional compositions.

Thus, the adhesive compositions described herein can be used for, e.g., packaging applications. The adhesive compositions perform equal to or better than conventional fast setting hot melt adhesives used in industry.

All documents described herein are incorporated by reference herein, including any priority documents and/or testing procedures to the extent they are not inconsistent with this text. As is apparent from the foregoing general description and the specific embodiments, while forms of the embodiments have been illustrated and described, various modifications can be made without departing from the spirit and scope of the present disclosure. Accordingly, it is not intended that the present disclosure be limited thereby. Likewise, the term “comprising” is considered synonymous with the term “including.” Likewise whenever a composition, an element or a group of elements is preceded with the transitional phrase “comprising,” it is understood that we also contemplate the same composition or group of elements with transitional phrases “consisting essentially of,” “consisting of,” “selected from the group of consisting of,” or “I” preceding the recitation of the composition, element, or elements and vice versa, e.g., the terms “comprising,” “consisting essentially of,” “consisting of” also include the product of the combinations of elements listed after the term.

For the sake of brevity, only certain ranges are explicitly disclosed herein. However, ranges from any lower limit may be combined with any upper limit to recite a range not explicitly recited, as well as, ranges from any lower limit may be combined with any other lower limit to recite a range not explicitly recited, in the same way, ranges from any upper limit may be combined with any other upper limit to recite a range not explicitly recited. Additionally, within a range includes every point or individual value between its end points even though not explicitly recited. Thus, every point or individual value may serve as its own lower or upper limit combined with any other point or individual value or any other lower or upper limit, to recite a range not explicitly recited.

All priority documents are herein fully incorporated by reference for all jurisdictions in which such incorporation is permitted and to the extent such disclosure is consistent with the description of the present disclosure. Further, all documents and references cited herein, including testing procedures, publications, patents, journal articles, etc. are herein fully incorporated by reference for all jurisdictions in which such incorporation is permitted and to the extent such disclosure is consistent with the description of the present disclosure.

While the present disclosure has been described with respect to a number of embodiments and examples, those skilled in the art, having benefit of the present disclosure, will appreciate that other embodiments can be devised which do not depart from the scope and spirit of the present disclosure as described herein.

We claim:

1. An adhesive composition, comprising:
(a) a propylene-based elastomer comprising at least 60 wt % of propylene-derived units and from 2 wt % to 40 wt % of a C₂ and/or a C₄-C₂₀ α-olefin-derived units based on a total weight of the propylene-based elastomer, and having a melting temperature of less than 110° C., a heat of fusion of less than 75 J/g, and a weight average molecular weight (Mw) of less than 100,000 g/mol;
(b) a polyethylene wax having a density of greater than 0.940 g/cm³, a weight average molecular weight (Mw) of from 3,000 g/mol to 30,000 g/mol, and a crystallization temperature of greater than 100° C.;
(c) a tackifier; and
(d) optionally a polypropylene wax.

2. The adhesive composition of claim 1, wherein the propylene-based elastomer has the weight average molecular weight of less than 50,000 g/mol.

3. The adhesive composition of claim 1, wherein the propylene-based elastomer has a melt viscosity, measured according to method ASTM D-3236 at 190° C., of less than 15,000 mPa·s.

4. The adhesive composition of claim 1, wherein the propylene-based elastomer has a melt viscosity, measured according to method ASTM D-3236 at 190° C., of from 250 mPa·s to 10,000 mPa·s.

5. The adhesive composition of claim 1, wherein the propylene-based elastomer has a melt flow rate, measured according to ASTM D-1238 at 230° C. and 2.16 kg, of greater than 250 dg/min.

6. The adhesive composition of claim 1, wherein the propylene-based elastomer comprises from 83 wt % to 97 wt % of propylene-derived units and from 3 wt % to 17 wt % ethylene-derived units based on the total weight of the propylene-based elastomer.

7. The adhesive composition of claim 1, wherein the propylene-based elastomer is present in the adhesive composition in an amount of from 65 wt % to 95 wt % based on the total weight of the adhesive composition.

8. The adhesive composition of claim 1, wherein the polyethylene wax has the weight average molecular weight of greater than 6,000 g/mol to 25,000 g/mol.

9. The adhesive composition of claim 1, wherein the polyethylene wax has the weight average molecular weight (Mw) of from 10,000 g/mol to 20,000 g/mol.

10. The adhesive composition of claim 1, wherein the polyethylene wax has a PDI of from 2 to 5.

11. The adhesive composition of claim 1, wherein the polyethylene wax has a density of greater than 0.95 g/cm³.

12. The adhesive composition of claim 1, wherein the polyethylene wax has the crystallization temperature of from 110° C. to 120° C.

13. The adhesive composition of claim 1, wherein the polyethylene wax is present in an amount of from about 1 wt % to about 25 wt % based on the total weight of the adhesive composition.

14. The adhesive composition of claim 1, wherein the polyethylene wax is present in an amount of from 5 wt % to about 15 wt % based on the total weight of the adhesive composition.

15. The adhesive composition of claim 1, wherein when the adhesive composition includes the tackifier, the tackifier comprises a hydrocarbon resin.

16. The adhesive composition of claim 15, wherein the hydrocarbon resin comprises an aliphatic hydrocarbon resin, a hydrogenated aliphatic hydrocarbon resin, an aromatic hydrocarbon resin, a hydrogenated aromatic hydrocarbon resin, a cycloaliphatic hydrocarbon resin, a hydrogenated cycloaliphatic hydrocarbon resin, a polyterpene resin, a terpene-phenol resin, a rosin ester resin, a rosin acid resin, or a combination thereof.

17. The adhesive composition of claim 15, wherein the hydrocarbon resin has a total dicyclopentadiene, cyclopentadiene, and methylcyclopentadiene derived content of from about 60 wt % to about 100 wt % of the total weight of the hydrocarbon resin and wherein the hydrocarbon resin has a weight average molecular weight of from 600 g/mol to 1400 g/mol.

18. The adhesive composition of claim 1, wherein when the adhesive composition includes the tackifier, the tackifier is present in an amount of from about 5 wt % to 34 wt % based on the total weight of the adhesive composition.

19. The adhesive composition of claim 1, wherein when the adhesive composition includes the tackifier, the tackifier is present in an amount of from 5 wt % to 15 wt % based on the total weight of the adhesive composition.

20. The adhesive composition of claim 1, wherein when the adhesive composition includes the polypropylene wax, the polypropylene wax is present in an amount of from about 0.5 wt % to 20 wt % based on the total weight of the adhesive composition.

21. The adhesive composition of claim 1, wherein when the adhesive composition includes the polypropylene wax, the polypropylene wax is present in an amount of from 1 wt % to 10 wt % based on the total weight of the adhesive composition.

22. The adhesive composition of claim 1, wherein when the adhesive composition includes the polypropylene wax, the polypropylene wax has a Mw/Mn of from 1.5 to 5.

23. The adhesive composition of claim 1 being substantially free of a functionalized polyolefin.

24. The adhesive composition of claim 1 having a crystallization temperature of greater than about 70° C.

25. The adhesive composition of claim 1 having an elongation at break, measured according to method ISO 37, of greater than about 150%.

26. The adhesive composition of claim 1 having a set time of less than 2.5 seconds.

27. The adhesive composition of claim 1 having a ΔT_{c} of 10° C. or more, wherein ΔT_{c} is defined as the difference between the crystallization temperature of the neat propylene-based elastomer and the crystallization temperature of the propylene-based elastomer blend and the one or more waxes.

28. The adhesive composition of claim 1 having a crystallization window of from 50° C. to 120° C.

29. An adhesive composition comprising:
70 wt % to 80 wt % of a propylene-based elastomer based on a total weight of the adhesive composition;
10 wt % of a polyethylene wax based on the total weight of the adhesive composition;
0 wt % to 10 wt % of a polypropylene wax based on the total weight of the adhesive composition; and
10 wt % of a tackifier based on the total weight of the adhesive composition.

30. The adhesive composition of claim 29 having a set time of from 1.25 seconds to 2.25 seconds.
